(19) United States
(12) Patent Application Publication
(10) Pub. No.: US 2009/0265031 A1
(43) Pub. Date: Oct. 22, 2009

(54) AUTOMATIC WAREHOUSE

(75) Inventors: Katsuyoshi Tachibana, Tokyo (JP); Motoyasu Ohata, Tokyo (JP); Yoichi Hirasawa, Tokyo (JP); Hiroshi Okubo, Tokyo (JP); Mitsuhiro Kato, Tokyo (JP)

Correspondence Address: BACON & THOMAS, PLLC, 625 SLATERS LANE, FOURTH FLOOR, ALEXANDRIA, VA, 22314-1176, US

(73) Assignee: HIRATA CORPORATION, TOKYO (JP)

(21) Appl. No.: 12/375,301

(22) PCT Filed: Sep. 27, 2007
(86) PCT No.: PCT/JP2007/068768

§ 371 Date: Feb. 12, 2009

(30) Foreign Application Priority Data
Sep. 28, 2006 (JP) PCT/JP2006/319388

(51) Int. Cl. B65G 1/00

(52) U.S. Cl. 700/214

(57) ABSTRACT

An automatic warehouse 1 includes a plurality of shelves 50 and a conveyance device 20. The plurality of shelves 50 are arranged in a horizontal direction and in a single level or in a plurality of levels and adapted to store storage objects. The conveyance device 20 is adapted to transfer the storage objects between the same and each of the plurality of shelves 50. All of the plurality of shelves 50 are implemented by a plurality of shelves 50 provided in a plurality of carriages 60 capable of moving between the inside of the automatic warehouse and the outside of the automatic warehouse. By use of the plurality of carriages 60 which also function as storage shelves, there can be provided an automatic warehouse having high degree of freedom and good storage efficiency, enabling efficient use of factory space, and being capable of coping with cell production.

### TECHNICAL FIELD

The present invention relates to an automatic warehouse, and more particularly to an automatic warehouse having high degree of freedom and good storage efficiency, enabling efficient use of factory space, and being capable of coping with cell production.

### BACKGROUND ART

FIGS. 6A to 6C show a conventional automatic warehouse 01, wherein FIG. 6A is a plan view, FIG. 6B is a front view, and FIG. 6C is a right side view.

The automatic warehouse 01 includes a pair of warehouse units 010a and 010b each having a plurality of shelves 050. The shelves 050 are arranged in the horizontal direction and in multiple levels. The warehouse units 010a and 010b stand facing each other with a conveyance device 020 provided therebetween. The conveyance device 020 assumes the form of a stacker crane or the like and transfers objects to be stored between the same and each of the shelves 050. The plurality of shelves 050 are all fixed shelves. A warehousing conveyor 030 conveys storage objects onto a loading position 031. The conveyance device 020 holds the conveyed storage objects on its mount table 025; travels on a travel rail 021; and transfers the storage objects onto a predetermined shelf 050. Also, the conveyance device 020 retrieves storage objects from a predetermined shelf 050 onto the mount table 025; travels on the travel rail 021; and transfers the storage objects onto an unloading position 041. A delivery conveyor 040 conveys the storage objects from the unloading position 041 to the outside of the automatic warehouse 01.

Through operation of drive means 022, the conveyance device 020 reciprocally travels on the travel rail 021. Also, a lifting table 024 of the conveyance device 020 moves vertically along a mast 023. Accordingly, the mount table 025 fixed on the lifting table 024 moves vertically.

The automatic warehouse 01 having the above-mentioned configuration fails to flexibly cope with changes in requirements for the number of shelves in response to demand and storage of various workpieces and involves troublesome work, since the area of a storage section must be partitioned for classification and management of storage objects.

Conventionally, an automatic warehouse of a certain type uses a portion of its storage section for accommodating carriages as disclosed in Patent Documents 1 and 2.

An automatic storage control system described in Patent Document 1 has a warehousing/delivery section at a portion of a storage rack unit. A carriage loaded with storage objects can enter and leave the warehousing/delivery section. However, the warehousing/delivery section can receive only a single carriage. A plurality of carriages are not intended to be used as a constituent of a storage section of the storage rack unit.

A storage apparatus described in Patent Document 2 has a plurality of storage sections arranged vertically and horizontally and a plurality of worktables provided at a predetermined height. A support body for supporting a control unit assumes the form of a carriage and is disposed in a side space next to the plurality of worktables in such a manner as to be able to be moved in and out from the space. However, the support body does not function as a shelf for placing and storing storage objects thereon. Not to mention, it is not intended that a plurality of the support bodies be used as a constituent of a storage section of the storage apparatus.

Furthermore, Patent Document 3 describes a manufacturing system using traveling storage racks and traveling loader/unloaders. A common interface is provided between the traveling storage racks and the traveling loader/unloaders. Also, a common interface is provided between the traveling loader/unloaders and the processing apparatus. This configurational feature imparts enhanced ability to continuously process workpieces to a higher extent without need to prepare excess loader/unloaders. However, this system is not intended for automatic warehouses.

Patent Document 1: Patent-Application Laid-Open (kokai) No.
Patent Document 2: Patent Application Laid-Open (kokai) No.
Patent Document 3: Patent Application Laid-Open (kokai) No.

### DISCLOSURE OF THE INVENTION

### Problems to be Solved by the Invention

An object of the present invention is to solve the above-mentioned problems in the conventional automatic warehouse and to provide an automatic warehouse using a plurality of carriages which also function as storage shelves, having high degree of freedom and good storage efficiency, enabling efficient use of factory space, and being capable of coping with cell production.

### Means for Solving the Problems

According to the present invention, the above-mentioned problems can be solved by the following automatic warehouse.

The automatic warehouse comprises a plurality of shelves and a conveyance device. The plurality of shelves are arranged in a horizontal direction and in a single level or in a plurality of levels and adapted to store storage objects. The conveyance device is adapted to transfer the storage objects between the same and each of the plurality of shelves. All of the plurality of shelves are implemented by a plurality of shelves provided in a plurality of carriages capable of moving between the inside of the automatic warehouse and the outside of the automatic warehouse.

The above-mentioned automatic warehouse can flexibly meet various configurational requirements for automatic warehouses, such as preparation of shelves in an amount that meets demand, and storage of various workpieces. Thus, there can be provided an automatic warehouse having high degree of freedom, high general versatility, and good storage efficiency, enabling efficient use of factory space, and being capable of coping with cell production.

According to a preferred embodiment, a warehouse unit is provided. The warehouse unit accommodates all of the plurality of shelves. A plurality of carriages are arranged in a horizontal direction, and each of the carriages internally has at least one shelf and can move between the inside of the automatic warehouse and the outside of the automatic warehouse. All of the plurality of shelves are implemented by a plurality of shelves provided in the plurality of carriages.

According to another preferred embodiment, the warehouse unit comprises a frame structure; the frame structure has a plurality of storage sections each having opening at one side of the frame structure or at both sides of the frame structure; and the carriages are disposed in the respective storage sections in such a manner as to be able to enter and leave the storage sections through the openings.

The automatic warehouse comprises a plurality of shelves and a conveyance device. The plurality of shelves are arranged in a horizontal direction and in a single level or in a plurality of levels and adapted to store storage objects. The conveyance device is adapted to transfer the storage objects between the same and each of the plurality of shelves. A portion of the plurality of shelves are implemented by a plurality of shelves provided in a plurality of carriages capable of moving between the inside of the automatic warehouse and the outside of the automatic warehouse.

The above-mentioned automatic warehouse can flexibly meet various configurational requirements for automatic warehouses, such as preparation of shelves in an amount that meets demand, and storage of various workpieces. Thus, there can be provided an automatic warehouse having high degree of freedom, high general versatility, and good storage efficiency, enabling efficient use of factory space, and being capable of coping with cell production.

Also, in order to classify and manage storage objects of small quantity and large variety, storage objects can be classified and managed per unit of the carriage, which also serves as the shelves. For example, when the carriage is set to store storage objects classified under a predetermined kind and becomes full of storage objects, this situation is readily coped with by replacing the carriage with an empty carriage, whereby storage operation can be continued. Component parts required for production of a product can be automatically prepared on a carriage basis by unloading the component parts from the shelves (shelves other than those provided in the carriages) onto the carriage. Also, upon occurrence of change in the type of the product, component parts stored in the carriage can be automatically changed, whereby production efficiency can be improved.

According to a preferred embodiment, a warehouse unit is provided. The warehouse unit accommodates all of the plurality of shelves. A plurality of carriages are arranged in a horizontal direction, and each of the carriages internally has at least one shelf and can move between the inside of the automatic warehouse and the outside of the automatic warehouse. A portion of the plurality of shelves are implemented by a plurality of shelves provided in the plurality of carriages.

According to another preferred embodiment, the warehouse unit comprises a frame structure. The frame structure has a plurality of storage sections each having opening at one side of the frame structure or at both sides of the frame structure, and a remaining portion of the plurality of shelves; and the carriages are disposed in the respective storage sections in such a manner as to be able to enter and leave the storage sections through the openings.

According to still another embodiment, the openings of the storage sections through which the carriages can enter and leave the respective storage sections are located at a side of the frame structure opposite a side toward a region where the conveyance device conveys the storage objects.

According to yet another embodiment, each of the storage sections has information input/output means and information read/write means, and each of the carriages has an identification member from which information is read.

According to a further embodiment, management means for managing a state of storage of the storage objects on the shelves provided in the carriages is further provided, and when the management means detects that the shelf provided in any one of the carriages is full of the storage objects, the management means outputs a carriage replacement signal for urging the carriage having the shelf full of the storage objects to leave an associated storage section and urging another carriage having an empty shelf to enter that storage section.

As mentioned above, through employment of the information input/output means and the information read/write means provided in the storage sections, the identification members attached to the carriages, and the management means for the storage objects stored on the shelves provided in the carriages, while information is exchanged with a central administrative computer, the management of entry and leaving of the carriages and the management of storage objects on the shelves provided in the carriages can be carried out integratively and comprehensively.

According to a still further embodiment, at least one of the plurality of shelves excluding the shelves provided in the carriages has a buffer function for temporarily storing the storage objects which overflow the shelves provided in the carriages. This configuration enables efficient storage management for standby workpieces. Also, by means of disposing and configuring the automatic warehouse of the present invention between two different work processes arranged in series, the automatic warehouse can absorb a difference in working time between the different work processes, and, even when trouble occurs in either one of the work processes, the automatic warehouse can carry out storage management so as to prevent influence of the trouble on the other work process.

According to a further embodiment, at least one of the plurality of shelves excluding the shelves provided in the carriages stores component parts required for production of a product, and the component parts required for production are supplied from the shelf to the shelf provided in the carriage which is short of the component parts required for production.

According to a further embodiment, the plurality of shelves are arranged in two parallel rows with the conveyance device disposed therebetween, or the warehouse unit is disposed in each of two parallel rows with the conveyance device disposed therebetween.

According to a further embodiment, among the plurality of shelves arranged in the two parallel rows, at least one shelf disposed in one of the two parallel rows is the shelf provided in the carriage which carries processed workpieces, and at least one shelf disposed in the other row is the shelf provided in the carriage which carries workpieces to be processed.

According to a further embodiment, at least one shelf disposed in the warehouse unit of one of the two parallel rows is the shelf provided in the carriage which carries processed workpieces, and at least one shelf disposed in the warehouse unit of the other row is the shelf provided in the carriage which carries workpieces to be processed.

By means of separating the shelf(ves) which stores processed workpieces, and the shelf(ves) which stores workpieces to be processed, from one another as mentioned above such that the shelf(ves) which stores processed workpieces are located on one side and the shelf(ves) which stores workpieces to be processed are located on the other side, the following configurational advantage can be yielded: with the automatic warehouse disposed between a preceding process and a posterior process, access positions at which the carriages which accommodate workpieces processed in the preceding process access the automatic warehouse can be set to be located on the one side, and access positions at which the carriages which accommodate workpieces to be processed in the posterior process access the automatic warehouse can be set to be located on the other side. Thus, the footprint of workpiece conveyance is shortened, so that processing in the preceding process and that in the posterior process can be carried out efficiently.

### EFFECTS OF THE INVENTION

As mentioned above, the automatic warehouse of the present invention can flexibly meet various configurational requirements for automatic warehouses, such as preparation of shelves in an amount that meets storage demand, and storage of various workpieces. Thus, there can be provided an automatic warehouse having high degree of freedom, high general versatility, and good storage efficiency, enabling efficient use of factory space, and being capable of coping with cell production.

Also, in order to classify and manage storage objects of small quantity and large variety, storage objects can be classified and managed per unit of carriage, which also serves as the shelves. For example, when the carriage is set to store storage objects classified under a predetermined kind and becomes full of storage objects, this situation is readily coped with by replacing the carriage with an empty carriage, whereby storage operation can be continued. Component parts required for production of a product can be automatically prepared on a carriage basis by unloading the component parts from the shelves onto the carriage. Also, upon occurrence of change in the type of the product, component parts stored in the carriage can be automatically changed, whereby production efficiency can be improved.

Also, through employment of the information input/output means and the information read/write means provided in the storage sections, the identification members attached to the carriages, and the management means for the storage objects stored on the shelves provided in the carriages, while information is exchanged with a central administrative computer, the management of entry and leaving of the carriages and the management of storage objects on the shelves provided in the carriages can be carried out integratively and comprehensively.

Furthermore, with the automatic warehouse disposed between a preceding process and a posterior process, access positions at which the carriages which accommodate workpieces processed in the preceding process access the automatic warehouse can be set to be located on one side, and access positions at which the carriages which accommodate workpieces to be processed in the posterior process access the automatic warehouse can be set to be located on the other side. Thus, the footprint of workpiece conveyance is shortened, so that processing in the preceding process and that in the posterior process can be carried out efficiently.

### BRIEF DESCRIPTION OF THE DRAWINGS

FIG. 1A is a plan view of an automatic warehouse according to an embodiment (first embodiment) of the present invention.

FIG. 1B is a front view of the automatic warehouse of the first embodiment.

FIG. 1C is a side view of the automatic warehouse of the first embodiment.

FIG. 2A is a plan view of a carriage which partially constitutes the automatic warehouse of the first embodiment.

FIG. 2B is a rear view of the carriage.

FIG. 2C is a side view of the carriage.

FIG. 3A is a plan view of an automatic warehouse according to another embodiment (third embodiment) of the present invention.

FIG. 3B is a front view of the automatic warehouse of the third embodiment.

FIG. 3C is a side view of the automatic warehouse of the third embodiment.

FIG. 4A is a plan view of a modified embodiment of the automatic warehouse of the third embodiment.

FIG. 4B is a front view of the modified embodiment.

FIG. 4C is a side view of the modified embodiment.

FIG. 5A is a plan view showing, in detail, the automatic warehouse of the first embodiment.

FIG. 5B is a front view showing, in detail, the automatic warehouse of the first embodiment.

FIG. 5C is a side view showing, in detail, the automatic warehouse of the first embodiment.

FIG. 6A is a plan view of a conventional automatic warehouse.

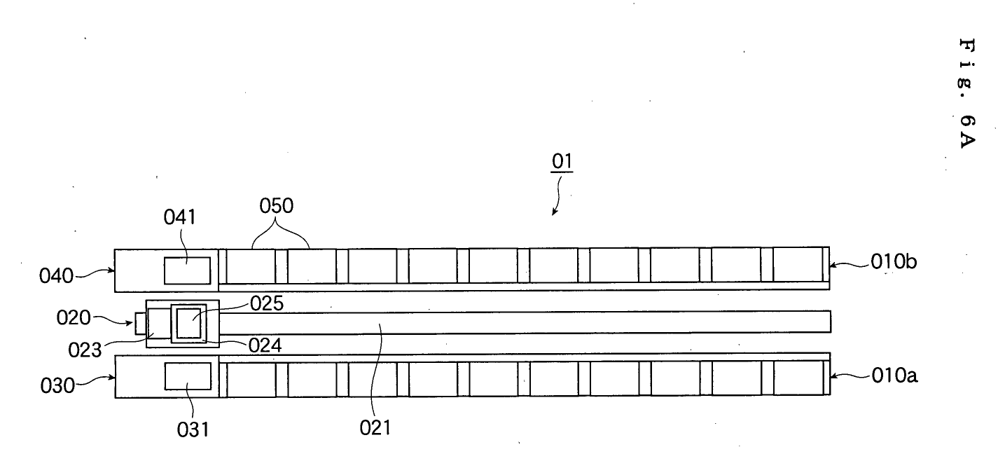

FIG. 6B is a front view of the conventional automatic warehouse.

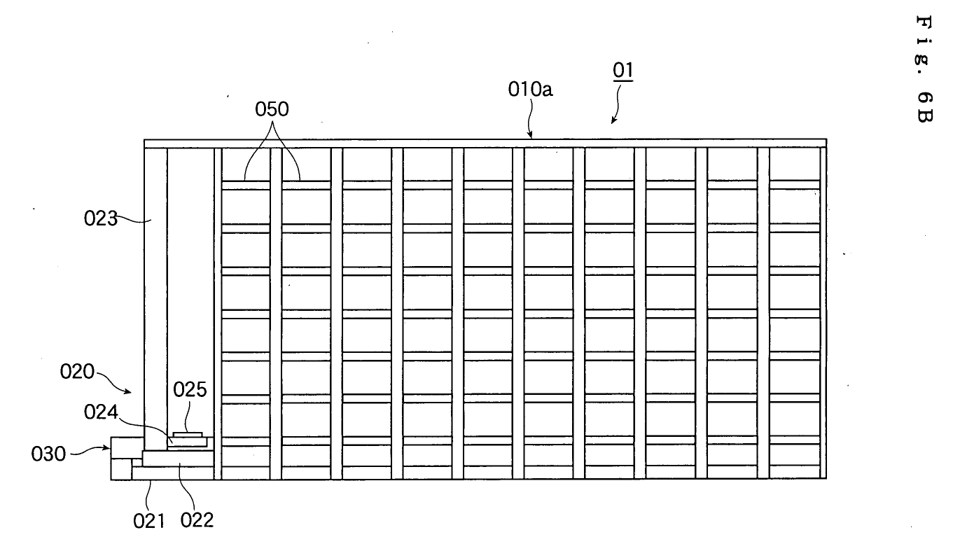

FIG. 6C is a side view of the conventional automatic warehouse.

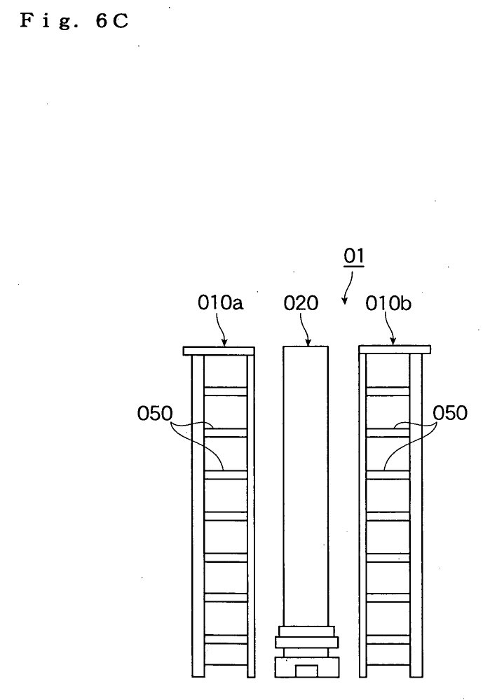

### DESCRIPTION OF REFERENCE NUMERALS

1: automatic warehouse; 10a, 10b: paired warehouse units; 11: frame structure; 12: storage section; 13: information input/output means; 14: information read/write means; 15: identification member; 20: conveyance device; 21: travel rail; 22: drive means; 23: mast; 24: lifting table; 25: mount table; 30: warehousing conveyor; 31: loading position; 40: delivery conveyor; 41: unloading position; 50: shelf; 60: carriage; 61: body; 62: caster; 63: handle

### BEST MODE FOR CARRYING OUT THE INVENTION

In an automatic warehouse which includes a plurality of shelves arranged in the horizontal direction and in multiple levels, and a conveyance device for transferring storage objects between the same and the shelves, all or a portion of the plurality of shelves are implemented by a plurality of carriages.

### EMBODIMENTS

Next, an embodiment (first embodiment) of the present invention will be described.

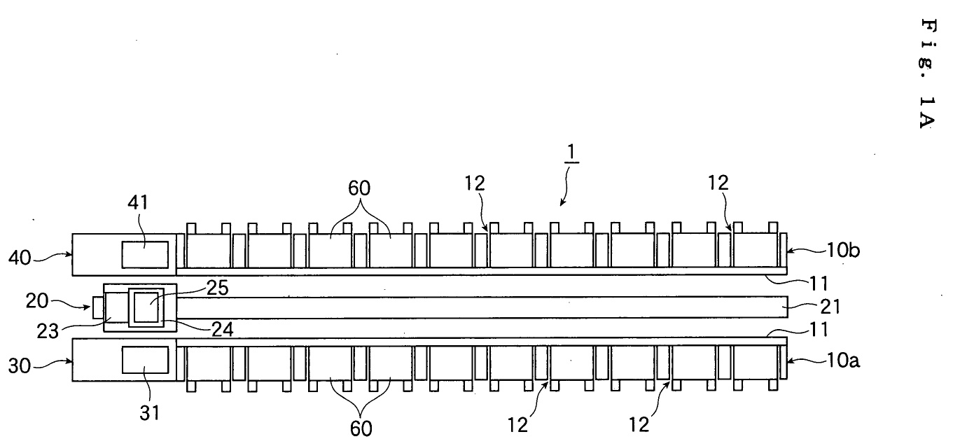

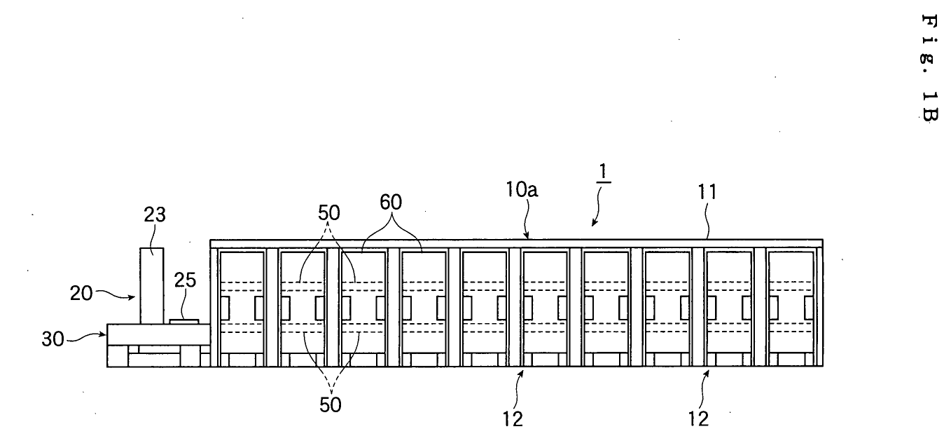

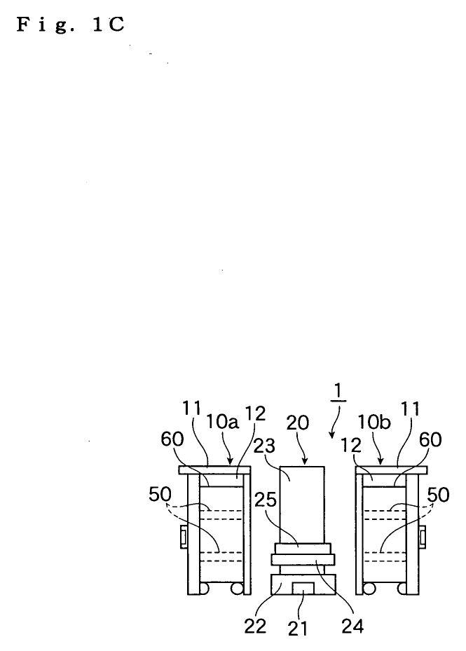

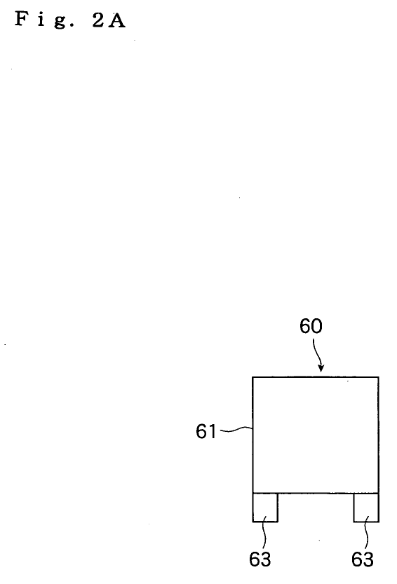

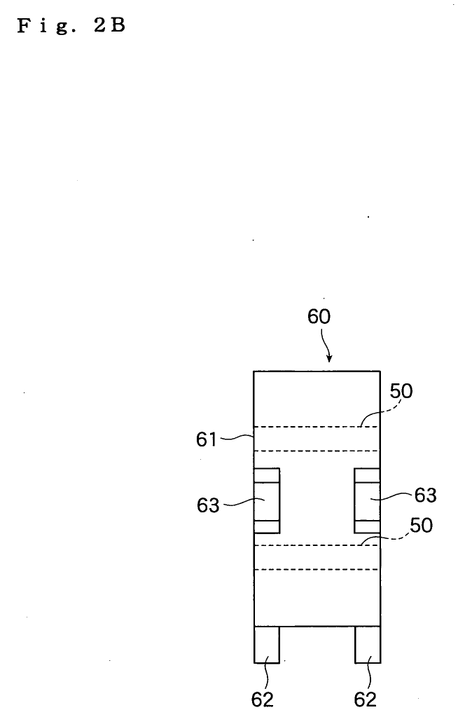

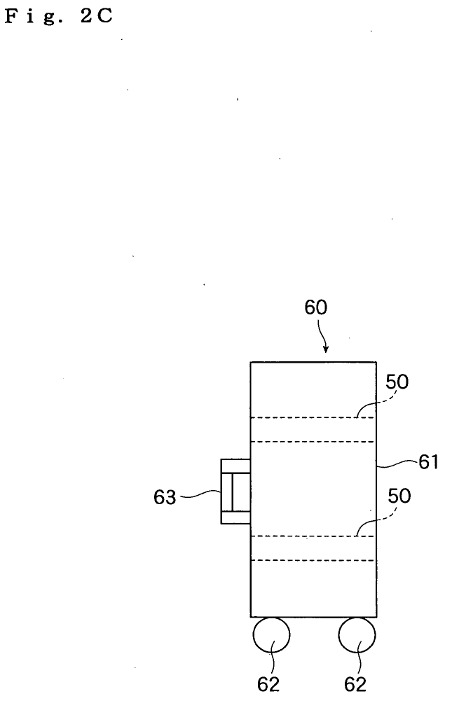

FIGS. 1A to 1C show an automatic warehouse of the first embodiment, wherein FIG. 1A is a plan view, FIG. 1B is a front view, and FIG. 1C is a side view. FIGS. 2A to 2C show a carriage which partially constitutes the automatic warehouse, wherein FIG. 2A is a plan view, FIG. 2B is a rear view, and FIG. 2C is a side view.

The automatic warehouse of the first embodiment is used in manufacturing-assembling factories of various products and is preferably used in factories which employ a cell production system.

FIGS. 1A to 1C schematically show the overall configuration of an automatic warehouse 1 of the first embodiment. As illustrated, paired warehouse units 10a and 10b are disposed in such a manner as to extend in the horizontal direction and face each other. A conveyance device 20 is disposed between the paired warehouse units 10a and 10b. Storage objects are transferred between the conveyance device 20 and each of a plurality of shelves provided in each of the paired warehouse units 10a and 10b.

At one end of the automatic warehouse 1, a loading position 31 where storage objects are loaded and an unloading position 41 where storage objects are unloaded are located in such a manner as to face each other with the movement area of the conveyance device 20 therebetween. The loading position 31 is connected to a warehousing conveyor 30, and the unloading position 41 is connected to a delivery conveyor 40.

Through operation of a drive means 22, the conveyance device 20 reciprocally travels on a travel rail 21 laid between the paired warehouse units 10a and 10b. Also, a lifting table 24 of the conveyance device 20 and a mount table 25 fixed on the lifting table 24 move vertically along a mast 23. Thus, the mount table 25 is moved to a predetermined target position for transfer of a storage object.

When storage objects are conveyed on the warehousing conveyor 30 and are then placed on the loading position 31, the conveyance device 20 transfers the storage objects onto the mount table 25 and holds the storage objects. Then, the conveyance device 20 travels on the travel rail 21 and then places the storage objects onto predetermined shelves 50. Also, the conveyance device 20 transfers storage objects from predetermined shelves 50 onto the mount table 25; travels on the travel rail 21; and places the storage objects on the unloading position 41. The storage objects are conveyed on the delivery conveyor 40 from the unloading position 41 to the outside of the automatic warehouse 1.

Each of the paired warehouse units 10a and 10b includes a frame structure 11 and a plurality of carriages 60. The frame structure 11 extends in the horizontal direction; serves as a frame of the corresponding warehouse unit 10a or 10b; and has a plurality of storage sections 12 each opening only at its one side of the frame structure 11. The frame structure 11 of the warehouse unit 10a and the frame structure 11 of the warehouse unit 10b are disposed in parallel with each other and in such a manner that the storage sections 12 of the former and the storage sections 12 of the latter are arranged back to back (back sides, which do not have openings, face each other). The carriages 60 are disposed in the respective storage sections 12, which are arranged in a row in the horizontal direction, in such a manner that the carriages 60 can enter and leave the respective storage sections 12. The carriages 60 move between the inside and the outside of the automatic warehouse 1 (between a preceding process and a posterior process, or the like, in a manufacturing-assembling factory). The storage sections 12 serve as access positions for the carriages 60 in access to the paired warehouse units 10a and 10b. The frame structure 11 may be a combination of vertical frames and horizontal frames or a combination of vertical plates and horizontal plates.

Each of the carriages 60 has two shelves 50 arranged in two levels. Accordingly, the aforementioned plurality of shelves provided in each of the paired warehouse units 10a and 10b are the shelves 50 in an amount obtained by two times the number of the carriages 60 present at the respective access positions in each of the paired warehouse units 10a and 10b. Thus, all of the plurality of shelves provided in the automatic warehouse 1 can be said to be implemented by the plurality of carriages 60 (more accurately, the shelves 50 provided in the plurality of carriages 60). The number of levels of the shelves 50 provided in each of the carriages 60 may be increased as appropriate or can be one.

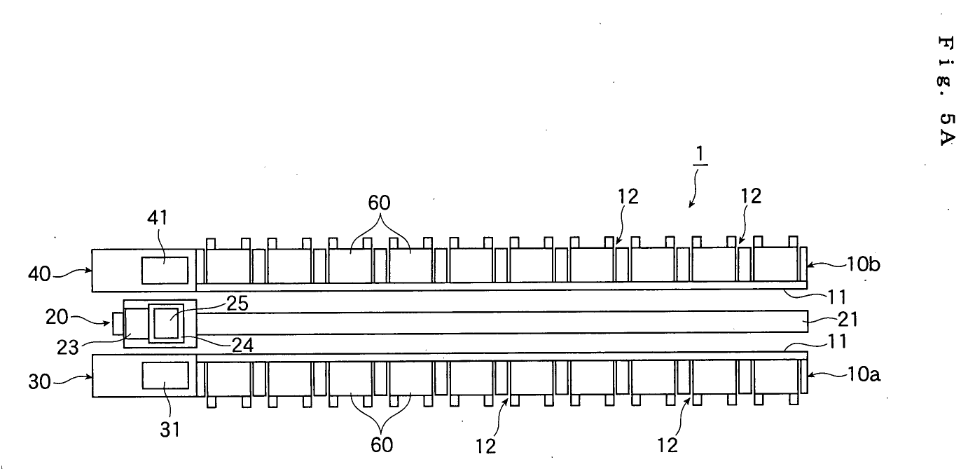

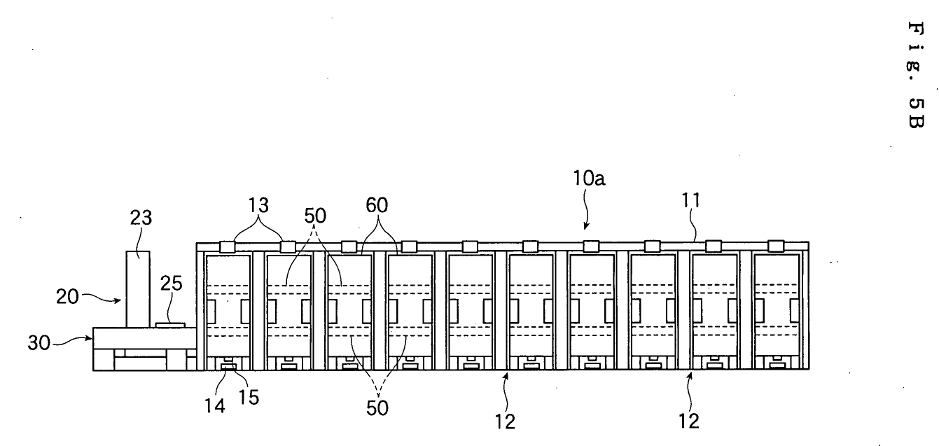

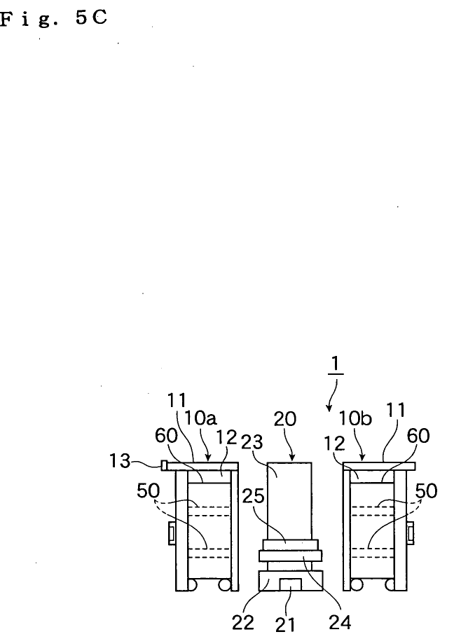

As shown in FIGS. 5(A) to 5(C), an information input/output means 13 and an information read/write means 14 are provided at each of the access positions (storage sections 12) for the carriages 60 in the frame structures 11 of the warehouse units 10a and 10b. The information read/write means 14 reads information of an identification member (ID tag or the like) 15 provided on the carriage 60 and sends the read carriage information to an administrative computer (not shown), which controls and administers the warehouse units 10a and 10b. Also, in the case where new storage objects are stored on the shelf 50 of the carriage 60, the administrative computer sends information about the new storage objects to the information read/write means 14, and the information read/write means 14 writes the information into the identification member 15 of the carriage 60.

Meanwhile, the information input/output means 13 is provided at an upper portion of each of the storage sections 12 and has a function as display means. Specifically, the information input/output means 13 receives information about storage objects stored in the carriage 60 from the administrative computer or the information read/write means 14 and displays the received information. Furthermore, by means of inputting into the information input/output means 13 information about storage objects which a user wants to store in the carriage 60, the information input/output means 13 sends to the administrative computer the information about the storage objects which the user wants to store in the carriage 60. In this manner, the information input/output means 13 can display carriage information (for example, information about storage objects stored on the shelf 50 of the carriage 60) and can input or output request information about storage objects which the user wants to store on the shelf 50 of the carriage 60.

A carriage detection means (sensor, not shown) is provided at each of the storage sections 12 for the carriages 60 in each of the frame structures 11 of the warehouse units 10a and 10b and is adapted to check whether or not the carriage 60 is present in the storage section 12. Furthermore, each of the storage sections 12 has a detection means (sensor, not shown) for detecting a state of storage (presence or absence of one or more storage objects) on the shelf 50 of the carriage 60, whereby a state of storage of storage objects on the shelf 50 of the carriage 60 is monitored. Alternatively, information about storage objects stored on the shelf 50 of the carriage 60 may be managed as follows. A radio frequency tag (RFID) is attached to every storage object; an information read means for reading the radio frequency tag is provided in each of the storage sections 12; information about a large number of storage objects stored on the shelves 50 of the carriages 60 is read all together; and the read commodity information is sent to an administrative computer.

The carriage 60 is configured as shown in FIGS. 2A to 2C. Specifically, a box body 61 having the form of a vertically elongated rectangular parallelepiped has casters 62 at four corners of its bottom portion; handles 63 on its back at left and right end portions of a substantially vertically central region; and two vertically arranged shelves 50 therein. The front face of the carriage 60 is opened so that storage objects can be placed in the shelves 50 and removed from the shelves 50.

Thus, while holding the handles 63, a worker can move the carriage 60 to any position by pushing or pulling the handles 63. For example, in the automatic warehouse 1, the worker can perform the following work. While holding and pulling the handles 63 of a carriage 60 full of storage objects, the worker withdraws the carriage 60 from the automatic warehouse 1. Then, while holding and pushing the handles 63 of an empty carriage 60, he/she moves the carriage into the vacant space of the automatic warehouse 1. In this manner, the automatic warehouse 1 can maintain reserve storage capacity at all times.

Being configured as described above, the automatic warehouse 1 of the first embodiment can yield the following effects.

Since all of the plurality of shelves of the automatic warehouse 1 are implemented by a plurality of the carriages each internally having an appropriate number of the shelves 50, the automatic warehouse 1 can flexibly meet various configurational requirements for automatic warehouses, such as preparation of shelves in an amount that meets demand, and storage of various workpieces. Thus, there can be provided an automatic warehouse having high degree of freedom, high general versatility, and good storage efficiency, enabling efficient use of factory space, and being capable of coping with cell production.

Also, through employment of the information input/output means 13, the information read/write means 14, the identification members 15 attached to the carriages 60, the carriage detection means, the detection means for detecting storage objects stored on the shelves 50 of the carriages 60, the radio frequency tags affixed to storage objects, the information read means for reading the radio frequency tags, etc., while information is exchanged with the administrative computer, the management of entry and leaving of the carriages 60 and the management of storage objects on the shelves 50 of the carriages 60 can be carried out integratively and comprehensively.

Next, another embodiment (second embodiment) of the present invention will be described.

An automatic warehouse 1 of the second embodiment differs from the automatic warehouse 1 of the first embodiment in that, among a plurality of the shelves 50 of the automatic warehouse 1, at least one shelf 50 disposed on one side is implemented by a processed carriage 60 which accommodates processed workpieces, and at least one shelf 50 disposed on the other side is implemented by an unprocessed carriage 60 which accommodates workpieces to be processed.

The terms “one side” and “the other side” indicate a positional relation between two shelves 50 disposed apart from each other. The positional relation can be of various kinds. For example, “at least one shelf 50 disposed on one side” can be at least one shelf 50 of a plurality of the shelves 50 provided in the warehouse unit 10a, whereas “at least one shelf 50 disposed on the other side” can be at least one shelf 50 of a plurality of the shelves 50 provided in the warehouse unit 10b. Also, for example, “at least one shelf 50 disposed on one side” can be at least one shelf 50 of a plurality of shelves 50 provided on a side toward one end of the warehouse unit 10a, whereas “at least one shelf 50 disposed on the other side” can be at least one shelf 50 of a plurality of the shelves 50 provided on a side toward the other end of the warehouse unit 10a.

The thus-configured automatic warehouse 1 can be disposed between a preceding process and a posterior process in a manufacturing-assembling factory of products. The access positions at which the carriages (processed carriages) 60 which accommodate workpieces processed in the preceding process access the automatic warehouse 1 can be set to be located on one side. The conveyance device 20 unloads the processed workpieces from the carriage 60 which has accessed the one side. The access positions at which the carriages (unprocessed carriages) 60 which accommodate the unloaded workpieces (workpieces to be processed in the posterior process) access the automatic warehouse 1 can be set to be located on the other side. The unprocessed carriage 60 is then moved to the predetermined posterior process.

Since the automatic warehouse 1 of the second embodiment is configured as described above, the footprint of conveyance of workpieces, such as component parts, between the preceding process and the posterior process is shortened. Thus, processing in the preceding process and that in the posterior process can be carried out efficiently. In the case where a manufacturing-assembling process is configured such that a preceding process and a posterior process are housed in separate rooms, the effect of the second embodiment will be found more useful.

Next, still another embodiment (third embodiment) of the present invention will be described.

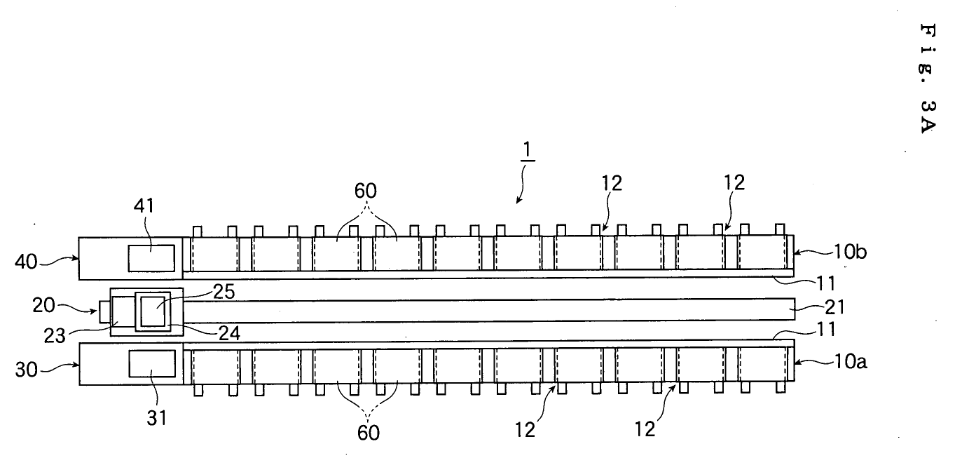

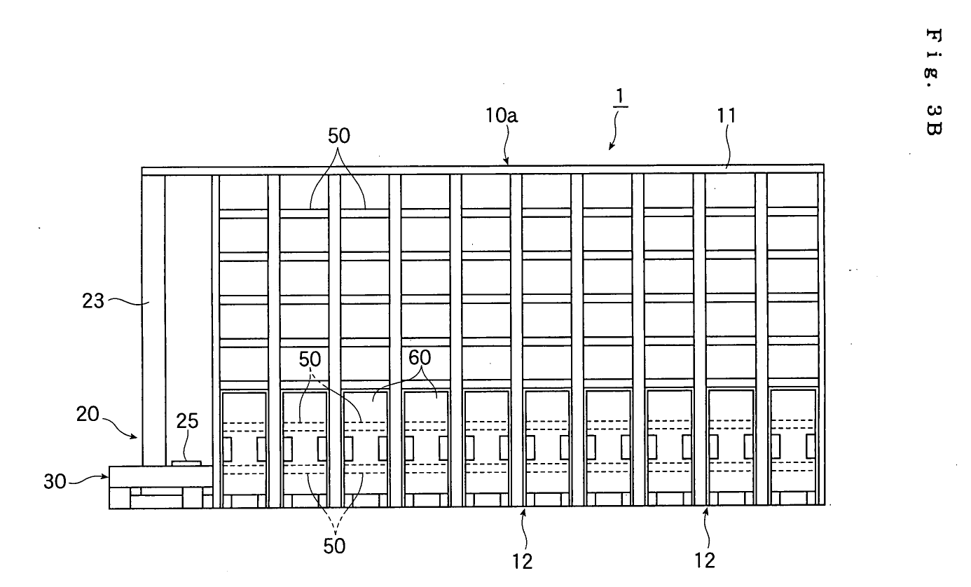

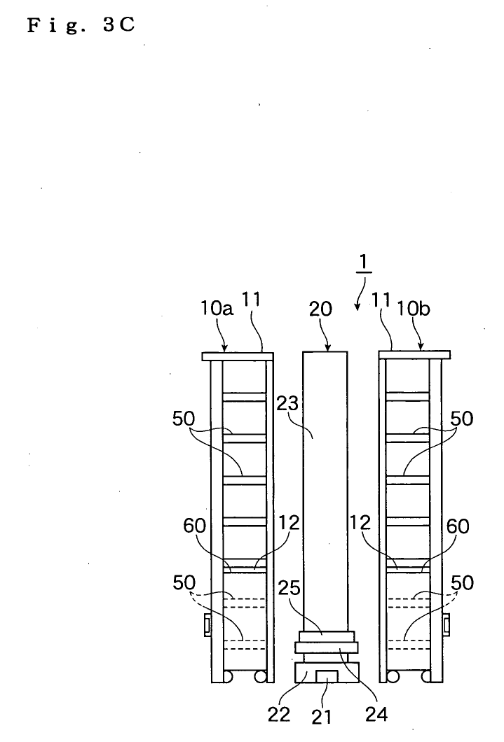

FIGS. 3A to 3C show an automatic warehouse of the third embodiment, wherein FIG. 3A is a plan view, FIG. 3B is a front view, and FIG. 3C is a side view.

The automatic warehouse 1 of the third embodiment differs from the automatic warehouse 1 of the first embodiment in that, as shown in FIGS. 3A to 3C, only a portion of the plurality of shelves provided in the automatic warehouse 1 are implemented by a plurality of the carriages 60 (more accurately, the shelves 50 of the plurality of carriages 60).

Specifically, a plurality of the shelves 50 provided in each of the paired warehouse units 10a and 10b are a set of the shelves 50 in an amount obtained by two times the number of the carriages 60 arranged in a horizontal row at a bottom portion of the automatic warehouse 1, and the shelves 50 which are arranged, above the plurality of carriages 60, in a horizontal row and in multiple levels in a frame structure of the automatic warehouse 1. Thus, only a portion of the plurality of shelves 50 provided in the automatic warehouse 1 of the third embodiment can be said to be implemented by the plurality of carriages 60 (more accurately, the shelves 50 provided in the plurality of carriages 60).

A buffer function can be imparted to a portion of the plurality of shelves 50 located above the plurality of carriages 60 and arranged in a horizontal row and in multiple levels in the frame structure of the automatic warehouse 1. This configurational feature yields the following effect. In the case where the processed carriages 60 and the unprocessed carriages 60 appearing in the description of the second embodiment are used as carriages which partially constitute the plurality of shelves 50 of the automatic warehouse 1, the shelves 50 having the buffer function can be used to temporarily accommodate, as standby workpieces, those unprocessed workpieces which overflow the unprocessed carriages 60. Thus, the standby workpieces can be efficiently stored and managed within the same automatic warehouse 1. Upon generation of a difference in processing time between a preceding process and a posterior process, the automatic warehouse 1 absorbs potential influence of the processing time difference on the processes (in the case of occurrence of abnormality in either of the processes; for example, in the case of occurrence of abnormality in the posterior process, products processed in the preceding process are buffered in the automatic warehouse 1, thereby preventing influence on processing in the preceding process; and in the case of occurrence of abnormality in the preceding process, products buffered in the automatic warehouse 1 are supplied to the posterior process without intermittence, thereby preventing influence on processing in the posterior process). Thus, optimum manufacturing-assembling process can be carried out.

Since the automatic warehouse 1 of the third embodiment is configured as described above, the automatic warehouse 1 can flexibly meet various configurational requirements for automatic warehouses, such as storage of various workpieces. Thus, there can be provided an automatic warehouse having high general versatility and good storage efficiency, enabling efficient use of factory space, and being capable of coping with cell production.

Also, in order to classify and manage storage objects of small quantity and large variety, storage objects can be classified and managed per unit of the carriage 60, which also serves as the shelves 50. For example, when the carriage 60 is set to store storage objects classified under a predetermined kind and becomes full of storage objects, the carriage 60 is replaced with another empty carriage 60, whereby storage operation can be continued without interruption. Also, a worker can more readily cope with work pertaining to carriage replacement. By means of disposing the automatic warehouse 1 of the third embodiment in the periphery of product assembly equipment of a certain production system (cell production, line production, or the like) composed of a plurality of assembly work processes, component parts required for production of products can be warehoused to the automatic warehouse 1 from the warehousing conveyor 30 and stored on the shelves 50 in advance or as needed. Thus, component parts required on a work process basis can be automatically unloaded from the shelves 50 (ordinary shelves 50 other than those provided in the carriages 60) on a carriage 60 basis and can be transported on the carriage 60 to a relevant work process. While component parts are managed collectively, only those component parts which are required for production of a single product can be managerially stored on a single carriage 60 and can be transported to a relevant work process. Therefore, work can be reliably carried out, and production efficiency can be enhanced.

In the case where the processed carriages 60 and the unprocessed carriages 60 are used as carriages which partially constitute the plurality of shelves 50 of the automatic warehouse 1, a portion of the plurality of shelves 50 which are located above the plurality of carriages 60 and have a buffer function can be used to temporarily accommodate, as standby workpieces, those unprocessed workpieces which overflow the unprocessed carriages 60. Thus, the standby workpieces can be efficiently stored and managed within the same automatic warehouse 1. Upon generation of a difference in processing time between a preceding process and a posterior process, the automatic warehouse 1 absorbs potential influence of the processing time difference on the processes. Thus, optimum manufacturing-assembling process can be carried out. Also, in the vicinity of processing stages where different processings are performed in the posterior process, the carriages 60 which carry workpieces requiring the different processings can stand by. Thus, upon completion of a certain processing of workpieces having undergone the processing, unprocessed workpieces can be immediately supplied to the corresponding processing stage.

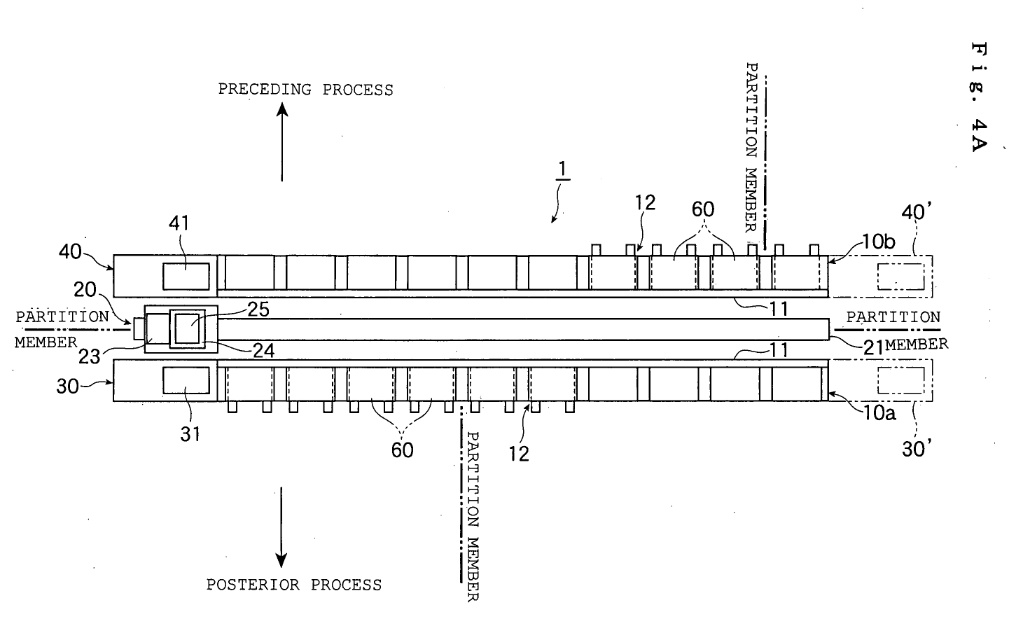

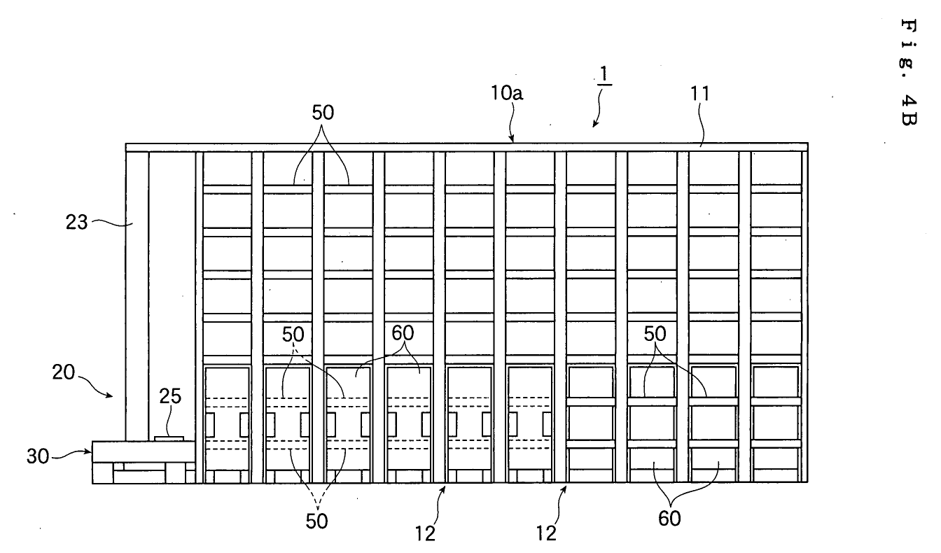

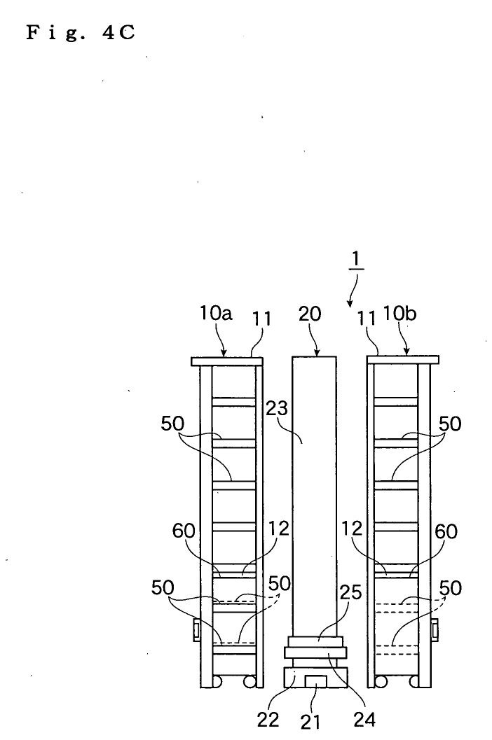

FIGS. 4A to 4C show a modified embodiment of the automatic warehouse 1 of the third embodiment.

According to the modified embodiment, the automatic warehouse 1 of the third embodiment is modified as follows: among a plurality of the carriages 60 arranged in a horizontal row at a bottom portion of the automatic warehouse 1 of the third embodiment, some carriages 60 (in FIGS. 4A and 4B, four carriages 60 from the right end of the warehouse unit 10a and six carriages 60 from the left end of the warehouse unit 10b) are eliminated. In a vacant space after the elimination of some carriages 60, a plurality of the shelves 50 are arranged in a horizontal row and in multiple levels through utilization of the frame structure of the automatic warehouse 1.

This modified embodiment can also yield effects similar to those which the automatic warehouse 1 of the third embodiment yields. Furthermore, the warehousing conveyor 30 and the delivery conveyor 40 may be eliminated. Also, as shown in FIG. 4A, a plurality of warehousing conveyors and a plurality of delivery conveyors may be employed through addition of a warehousing conveyor 30′ and a delivery conveyor 40′.

Also, not only is the automatic warehouse 1 disposed between a preceding process and a posterior process, but also, as shown in FIG. 4A, the automatic warehouse 1 may extend through a plurality of different processes which are separated from one another by means of partition members or through a plurality of independent rooms, such as processing chambers, which are separated from one another by means of partition members. By means of such a configuration being imparted to the automatic warehouse 1, storage management can be carried out more flexibly and efficiently.

The present invention is not limited to the above-described embodiments and modified embodiment. Numerous modifications and variations of the present invention are possible without departing from the gist of the invention.

For example, in the above-described embodiments and modified embodiment, the carriages 60 are disposed at a bottom portion of the automatic warehouse 1 (on a bottom floor). However, the present invention is not limited thereto. In the case where a plurality of floors of different levels (floors of a plurality of stories) extend between the inside and the outside of the automatic warehouse 1, the carriages 60 may be disposed as appropriate on a floor above the bottom floor. The conveyance device 20 moves through the plurality of floors and conveys storage objects to and from the shelves or carriages on the individual floors.

1. An automatic warehouse comprising a plurality of shelves and a conveyance device,
the plurality of shelves being arranged in a horizontal direction and in a single level or in a plurality of levels and adapted to store storage objects,
the conveyance device being adapted to transfer the storage objects between the same and each of the plurality of shelves,
wherein all of the plurality of shelves are provided in a plurality of carriages capable of moving between the inside of the automatic warehouse and the outside of the automatic warehouse.

2. An automatic warehouse comprising a warehouse unit and a conveyance device,
the warehouse unit accommodating all of a plurality of shelves arranged in a horizontal direction and in a single level or in a plurality of levels and adapted to store storage objects,
the conveyance device being adapted to transfer the storage objects between the same and each of the plurality of shelves,
wherein a plurality of carriages are arranged in a horizontal direction, and each of the carriages internally has at least one shelf and can move between the inside of the automatic warehouse and the outside of the automatic warehouse, and
all of the plurality of shelves are provided in the plurality of carriages.

3. An automatic warehouse according to claim 2, wherein:
the warehouse unit comprises a frame structure;
the frame structure has a plurality of storage sections each having an opening at one side of the frame structure or at both sides of the frame structure; and
the carriages are disposed in the respective storage sections in such a manner as to be able to enter and leave the storage sections through the openings.

4. An automatic warehouse comprising a plurality of shelves and a conveyance device,
the plurality of shelves being arranged in a horizontal direction and in a single level or in a plurality of levels and adapted to store storage objects,
the conveyance device being adapted to transfer the storage objects between the same and each of the plurality of shelves,
wherein a portion of the plurality of shelves are provided in a plurality of carriages capable of moving between the inside of the automatic warehouse and the outside of the automatic warehouse.

5. An automatic warehouse comprising a warehouse unit and a conveyance device,
the warehouse unit accommodating all of a plurality of shelves arranged in a horizontal direction and in a single level or in a plurality of levels and adapted to store storage objects,
the conveyance device being adapted to transfer the storage objects between the same and each of the plurality of shelves,
wherein a plurality of carriages are arranged in a horizontal direction, and each of the carriages internally has at least one shelf and can move between the inside of the automatic warehouse and the outside of the automatic warehouse, and
a portion of the plurality of shelves are provided in the plurality of carriages.

6. An automatic warehouse according to claim 5, wherein:
the warehouse unit comprises a frame structure;
the frame structure has a plurality of storage sections each an having opening at one side of the frame structure or at both sides of the frame structure, and a remaining portion of the plurality of shelves; and
the carriages are disposed in the respective storage sections in such a manner as to be able to enter and leave the storage sections through the openings.

7. An automatic warehouse according to claim 6, wherein the openings of the storage sections through which the carriages can enter and leave the respective storage sections are located at a side of the frame structure opposite a side toward a region where the conveyance device conveys the storage objects.

8. An automatic warehouse according to any one of claims 7, wherein:
each of the storage sections has information input/output means and information read/write means, and
each of the carriages has an identification member from which information is read.

9. An automatic warehouse according to claim 8, wherein:
management means for managing a state of storage of the storage objects on the shelves provided in the carriages is further provided, and
when the management means detects that the shelf provided in any one of the carriages is full of the storage objects, the management means outputs a carriage replacement signal for urging the carriage having the shelf full of the storage objects to leave an associated storage section and urging another carriage having an empty shelf to enter that storage section.

10. An automatic warehouse according to claim 9, wherein at least one of the plurality of shelves excluding the shelves provided in the carriages has a buffer function for temporarily storing the storage objects which overflow the shelves provided in the carriages.

11. An automatic warehouse according to claim 10, wherein at least one of the plurality of shelves excluding the shelves provided in the carriages stores component parts required for production of a product, and the component parts required for production are supplied from the shelf to the shelf provided in the carriage which is short of the component parts required for production.

12. An automatic warehouse according to claim 11, wherein the plurality of shelves are arranged in two parallel rows with the conveyance device disposed therebetween.

13. An automatic warehouse according to claim 11, wherein the warehouse unit is disposed in each of two parallel rows with the conveyance device disposed therebetween.

14. An automatic warehouse according to claim 12, wherein:
among the plurality of shelves arranged in the two parallel rows, at least one shelf disposed in one of the two parallel rows is the shelf provided in the carriage which carries processed workpieces, and
at least one shelf disposed in the other row is the shelf provided in the carriage which carries workpieces to be processed.

15. An automatic warehouse according to claim 13, wherein:
at least one shelf disposed in the warehouse unit of one of the two parallel rows is the shelf provided in the carriage which carries processed workpieces, and
at least one shelf disposed in the warehouse unit of the other row is the shelf provided in the carriage which carries workpieces to be processed.

16. An automatic warehouse according to claim 3, wherein the openings of the storage sections through which the carriages can enter and leave the respective storage sections are located at a side of the frame structure opposite a side toward a region where the conveyance device conveys the storage objects.

17. An automatic warehouse according to claim 1, wherein the plurality of shelves are arranged in two parallel rows with the conveyance device disposed therebetween.

18. An automatic warehouse according to claim 4, wherein the plurality of shelves are arranged in two parallel rows with the conveyance device disposed therebetween.

19. An automatic warehouse according to claim 10, wherein the plurality of shelves are arranged in two parallel rows with the conveyance device disposed therebetween.

20. An automatic warehouse according to claim 2, wherein the warehouse unit is disposed in each of two parallel rows with the conveyance device disposed therebetween.

21. An automatic warehouse according to claim 5, wherein the warehouse unit is disposed in each of two parallel rows with the conveyance device disposed therebetween.

22. An automatic warehouse according to claim 10, wherein the warehouse unit is disposed in each of two parallel rows with the conveyance device disposed therebetween.

23. An automatic warehouse according to claim 17, wherein:
among the plurality of shelves arranged in the two parallel rows, at least one shelf disposed in one of the two parallel rows is the shelf provided in the carriage which carries processed workpieces, and
at least one shelf disposed in the other row is the shelf provided in the carriage which carries workpieces to be processed.

24. An automatic warehouse according to claim 18, wherein:
among the plurality of shelves arranged in the two parallel rows, at least one shelf disposed in one of the two parallel rows is the shelf provided in the carriage which carries processed workpieces, and
at least one shelf disposed in the other row is the shelf provided in the carriage which carries workpieces to be processed.

25. An automatic warehouse according to claim 19, wherein:
among the plurality of shelves arranged in the two parallel rows, at least one shelf disposed in one of the two parallel rows is the shelf provided in the carriage which carries processed workpieces, and
at least one shelf disposed in the other row is the shelf provided in the carriage which carries workpieces to be processed.

26. An automatic warehouse according to claim 20, wherein:
at least one shelf disposed in the warehouse unit of one of the two parallel rows is the shelf provided in the carriage which carries processed workpieces, and
at least one shelf disposed in the warehouse unit of the other row is the shelf provided in the carriage which carries workpieces to be processed.

27. An automatic warehouse according to claim 21, wherein:
at least one shelf disposed in the warehouse unit of one of the two parallel rows is the shelf provided in the carriage which carries processed workpieces, and
at least one shelf disposed in the warehouse unit of the other row is the shelf provided in the carriage which carries workpieces to be processed.

28. An automatic warehouse according to claim 22, wherein:
at least one shelf disposed in the warehouse unit of one of the two parallel rows is the shelf provided in the carriage which carries processed workpieces, and
at least one shelf disposed in the warehouse unit of the other row is the shelf provided in the carriage which carries workpieces to be processed.

29. An automatic warehouse according to claim 4, wherein at least one of the plurality of shelves excluding the shelves provided in the carriages has a buffer function for temporarily storing the storage objects which overflow the shelves provided in the carriages.

30. An automatic warehouse according to claim 4, wherein at least one of the plurality of shelves excluding the shelves provided in the carriages stores component parts required for production of a product, and the component parts required for production are supplied from the shelf to the shelf provided in the carriage which is short of the component parts required for production.

31. An automatic warehouse according to any one of claims 16, wherein:
each of the storage sections has information input/output means and information read/write means, and
each of the carriages has an identification member from which information is read.

32. An automatic warehouse according to any one of claims 3, wherein:
each of the storage sections has information input/output means and information read/write means, and
each of the carriages has an identification member from which information is read.

33. An automatic warehouse according to any one of claims 6, wherein:
each of the storage sections has information input/output means and information read/write means, and
each of the carriages has an identification member from which information is read.
